(19) United States
(12) Patent Application Publication
(10) Pub. No.: US 2019/0264851 A1
(43) Pub. Date: Aug. 29, 2019

(54) CONNECTING STRUCTURE

(71) Applicant: TOYOTA JIDOSHA KABUSHIKI KAISHA, Toyota-shi (JP)

(72) Inventor: Keigo NOGUCHI, Toyota-shi (JP)

(73) Assignee: TOYOTA JIDOSHA KABUSHIKI KAISHA, Toyota-shi (JP)

(21) Appl. No.: 16/287,011

(22) Filed: Feb. 27, 2019

(30) Foreign Application Priority Data
Feb. 28, 2018 (JP) 2018-035147

(51) Int. Cl. F16L 37/12

(52) U.S. Cl. CPC F16L 37/1225

(57) ABSTRACT

A connecting structure for connecting a tube to a component, including: a receiving bore in the component; a connector including elastically bendable arms, one end of the tube axially extending through the connector and surrounded by the arms in a state in which the connector is inserted into the component; and a holding and withdrawal prohibiting mechanism including: first engaging portions each provided on an outer circumferential portion of a distal end of a corresponding one of the arms; and a second engaging portion provided on an inner circumferential surface of the bore, wherein, when the connector is biased in a withdrawal direction opposite to an insertion direction in which the connector is inserted, the mechanism prohibits a movement of the connector relative to the component in the withdrawal direction while gripping the tube by the arms, owing to engagement of the first engaging portions and the second engaging portion.

### CROSS REFERENCE TO RELATED APPLICATION

The present application claims priority from Japanese Patent Application No. 2018-035147, which was filed on Feb. 28, 2018, the disclosure of which is herein incorporated by reference in its entirety.

### BACKGROUND

### Technical Field

The following disclosure relates to a connecting structure employed in a fluid system.

### Description of Related Art

In a fluid system such as an oil hydraulic system, a fluid is often supplied into or from a component of the system via a tube, and a connecting structure is used to connect the component and the tube. One example of the connecting structure is disclosed in Japanese Patent Application Publication No. 2008-232438.

### SUMMARY

In the connecting structure described in the Publication, in the case where a force to withdraw the tube from the component acts on the tube, the entirety of the force is received by a retainer configured to retain a flange formed on the tube. From the viewpoint of providing a tough connecting structure, the strength of the retainer is significant. Accordingly, the present disclosure is directed to a connecting structure having a high strength.

In one aspect of the disclosure, a connecting structure is for connecting a tube to a component via a connector including a plurality of arms to be disposed in a receiving bore of the component so as to surround the tube. The connecting structure includes: a holding and withdrawal prohibiting mechanism including first engaging portions each provided on an outer circumferential portion of a distal end of a corresponding one of the plurality of arms; and a second engaging portion provided on an inner circumferential surface of the receiving bore so as to be engageable with the first engaging portions. When the connector is biased in a withdrawal direction, the holding and withdrawal prohibiting mechanism prohibits a movement of the connector in the withdrawal direction relative to the component while gripping the tube by the plurality of arms, owing to engagement of the first engaging portions and the second engaging portion.

### Advantageous Effects

According to the connecting structure constructed as described above, the plurality of arms tightly hold or grip the tube even when a force in the withdrawal direction acts on the tube, so that at least a part of the force that acts on the tube is received by the component via the plurality of arms. Thus, the connecting structure having a high strength can be obtained.

### Forms of the Invention

There will be exemplified and explained various forms of an invention that is considered claimable. (The invention will be hereinafter referred to as “claimable invention” where appropriate). Each of the forms is numbered like the appended claims and depends from the other form or forms, where appropriate. This is for easier understanding of the claimable invention, and it is to be understood that combinations of constituent elements that constitute the invention are not limited to those described in the following forms. That is, it is to be understood that the claimable invention shall be construed in the light of the following description of various forms and embodiments. It is to be further understood that, as long as the claimable invention is construed in this way, any form in which one or more constituent elements is/are added to or deleted from any one of the following forms may be considered as one form of the claimable invention.

(1) A connecting structure employed in a fluid system for connecting a tube to a component of the fluid system such that a fluid is allowed to flow into and out of the component, including:

a receiving bore provided in the component and opening at one end thereof; and

a connector including (a) a connector body and (b) a plurality of arms extending from the connector body along an axis so as to be arranged about the axis, each of the plurality of arms being elastically bendable such that a distal end thereof gets closer to the axis, the connector being inserted into the component in an axial direction in which the axis extends such that the plurality of arms are disposed in the receiving bore, one end of the tube extending through the connector in the axial direction so as to be surrounded by the plurality of arms in a state in which the connector is inserted into the component,

wherein the connecting structure further comprises a holding and withdrawal prohibiting mechanism including: first engaging portions each provided on an outer circumferential portion of the distal end of a corresponding one of the plurality of arms; and a second engaging portion provided on an inner circumferential surface of the receiving bore so as to be engageable with the first engaging portions, and

wherein, when the connector is biased in a withdrawal direction opposite to an insertion direction in which the connector is inserted into the component, the holding and withdrawal prohibiting mechanism prohibits a movement of the connector relative to the component in the withdrawal direction while gripping the tube by the plurality of arms, owing to engagement of the first engaging portions and the second engaging portion.

This form is a basic form of the claimable invention. According to the connecting structure of this form, the holding and withdrawal prohibiting mechanism enables the plurality of arms to tightly hold the tube such that the tube is gripped by the plurality of arms even when a force in the withdrawal direction acts on the tube. In this configuration, at least a part of the force that acts on the tube is received, via the arms, by the component at the inner circumferential surface of the receiving bore. Thus, the connecting structure having a sufficiently high strength is obtained according to this form.

Each of the arms in this form may be called a duckbill. In this form, it may be considered that the plurality of arms constitute a sleeve whose proximal end is integral with the connector body and which is divided into a plurality of circumferential segments extending along the axis. In this form, the tube is insertable into a space defined by the plurality of arms, namely, an inner space of the sleeve.

(2) The connecting structure according to the form (1), wherein one of: each of the first engaging portions; and the second engaging portion is an inclined surface that is inclined with respect to the axis.

According to this form, the holding and withdrawal prohibiting mechanism effectively prohibits the movement of the connector in the withdrawal direction relative to the component while permitting the plurality of arms to grip the tube, owing to a wedge effect of the inclined surfaces exhibited when the force in the withdrawal direction acts on the connector, namely, owing to an effect that the distal ends of the respective arms are biased in a direction toward the axis.

(3) The connecting structure according to the form (2), wherein, where the inclined surface is a first inclined surface, the other of: each of the first engaging portions; and the second engaging portion is a second inclined surface configured to be opposed to the first inclined surface when the first engaging portions and the second engaging portion come into engagement with each other.

According to this form, both of the first engaging portions and the second engaging portion are formed as the inclined surfaces, enabling the wedge effect to be exhibited smoothly.

(4) The connecting structure according to any one of the forms (1) through (3), further including a flange provided on an outer circumference of the tube,

wherein a movement of the connector in the insertion direction is prohibited in the state in which the connector is inserted into the component, and the connector is configured to stop the flange so as to prohibit a movement of the tube in the insertion direction relative to the connector.

According to this form, the movement of the tube in the insertion direction relative to the connector is also effectively prohibited in a state in which the tube and the component are connected, i.e., in a connected state.

(5) The connecting structure according to the form (4), further including a retainer held by the connector body of the connector and configured to retain the flange so as to prohibit a movement of the tube in the withdrawal direction relative to the connector.

This form adds limitation to the structure for stopping the flange in the connected state. According to this form, the movement of the tube in the withdrawal direction relative to the connector is prohibited by the retainer. Further, the tube is prohibited from being withdrawn also by the holding and withdrawal prohibiting mechanism. Thus, a force that the retainer receives for prohibiting the withdrawal of the tube is relatively small.

(6) The connecting structure according to the form (5), wherein the retainer is held by the connector body of the connector so as to be movable between a first position at which the retainer does not retain the flange and a second position at which the retainer retains the flange.

According to this form, the retainer is located at the position at which the retainer does not stop the flange when work of connecting the tube to the component is conducted, thus facilitating the connecting work.

(7) The connecting structure according to any one of the forms (1) through (6), further including a seal member disposed forward of the distal end of each of the plurality of arms of the connector in the insertion direction, so as to fluid-tightly seal between an outer circumferential surface of the tube and the inner circumferential surface of the receiving bore.

According to this form, the seal member effectively prevents leakage of the fluid from between the component and the tube.

(8) The connecting structure according to the form (7),

wherein the receiving bore includes a stepped surface by which a movement of the seal member in the insertion direction is prohibited, and

wherein the seal member is pushed onto the stepped surface by the distal end of each of the plurality of arms in the state in which the connector is inserted into the component.

This form enables the holding and withdrawal prohibiting mechanism to effectively exhibit, in the connected state of the tube and the component, its function utilizing the elastic reaction force of the seal member.

### BRIEF DESCRIPTION OF THE DRAWINGS

The objects, features, advantages, and technical and industrial significance of the present disclosure will be better understood by reading the following detailed description of an embodiment, when considered in connection with the accompanying drawings, in which:

FIG. 1 is a perspective view of a connecting structure according to one embodiment;

FIG. 2 is a side view of the connecting structure illustrated in FIG. 1;

FIGS. 3A and 3B are views of a tube, a connector, a retainer, etc., in FIG. 2, the views being viewed in an axial direction;

FIG. 4 is a cross-sectional view of the connecting structure illustrated in FIG. 1; and

FIGS. 5A and 5B are cross-sectional views respectively illustrating connecting structures according to modifications.

### DETAILED DESCRIPTION OF THE EMBODIMENT

A connecting structure according to one embodiment of the claimable invention will now be explained in detail with reference to the drawings. It is to be understood that the claimable invention is not limited to the details of the following embodiment but may be changed and modified based on the knowledge of those skilled in the art.

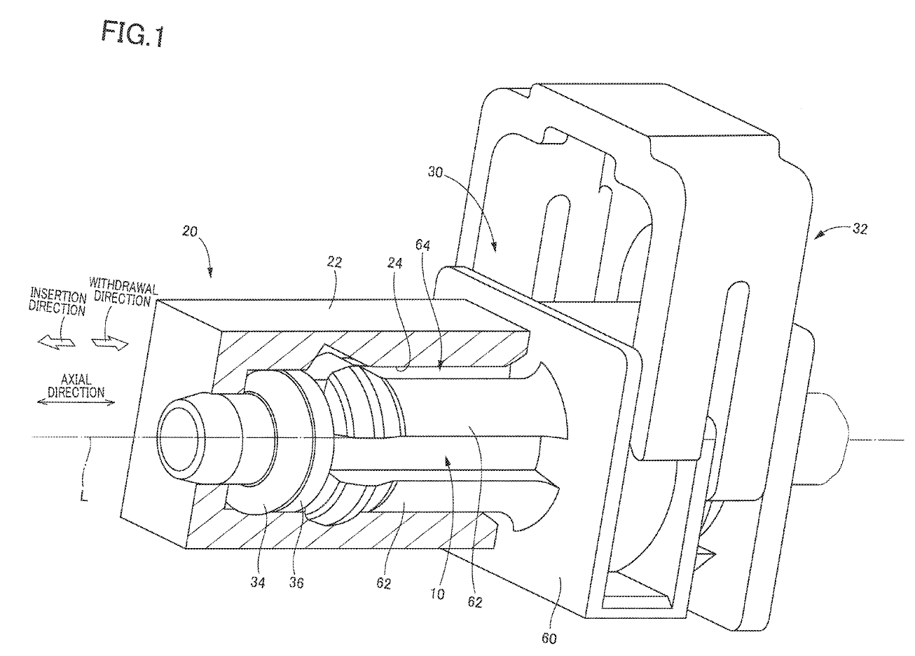

As shown in FIG. 1, a connecting structure according to the present embodiment (hereinafter referred to as “present connecting structure” where appropriate) is used in a fluid system. Specifically, the fluid system in which the present connecting structure is employed is a hydraulic brake system for vehicles utilizing a working fluid as a fluid. The connecting structure is for connecting a tube 10 to a component 20 of the fluid system such that the fluid is allowed to flow into and out of the component 20. Examples of the component 20 include a master cylinder, a brake actuator constituted by electromagnetic valves, etc., and a pump device. The drawing schematically illustrates only a part of the component 20, specifically, only a part of a housing 22 of the component 20. The tube 10 is connected to the housing 22 of the component 20. The axis of the tube 10 connected to the component 20 coincides or aligns with an axis L of the connecting structure. In the following explanation, a direction in which the axis L extends is referred to as an axial direction. As later explained in detail, the tube 10 is connected to the component 20 such that the tube 10 is inserted from a right side to a left side in the drawing along the axis L. Accordingly, a direction from the right side to the left side in the axial direction in the drawing will be referred to as an insertion direction while a direction opposite to the insertion direction, namely, a direction from the left side to the right side in the axial direction in the drawing, will be referred to as a withdrawal direction.

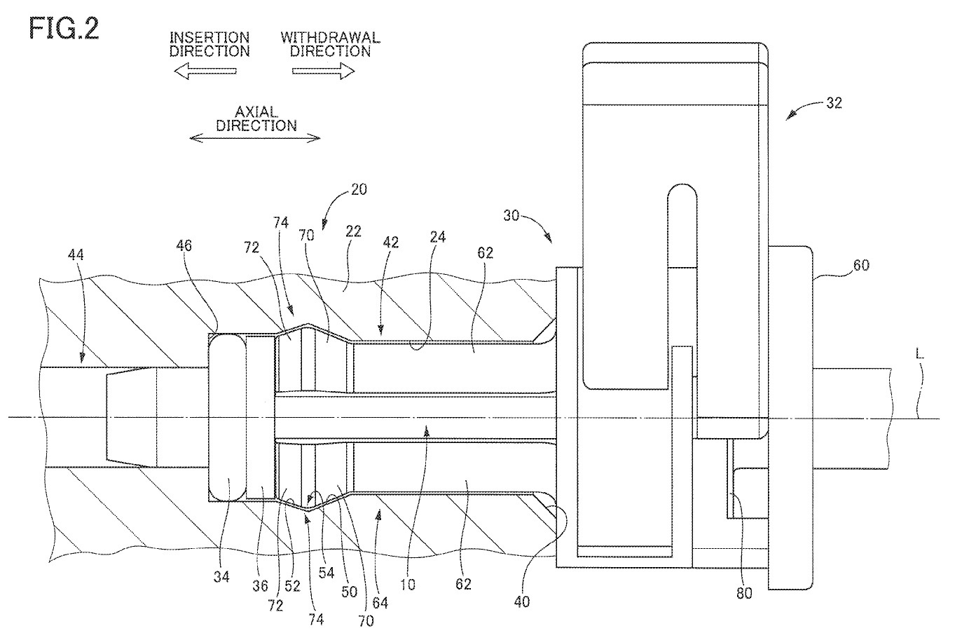

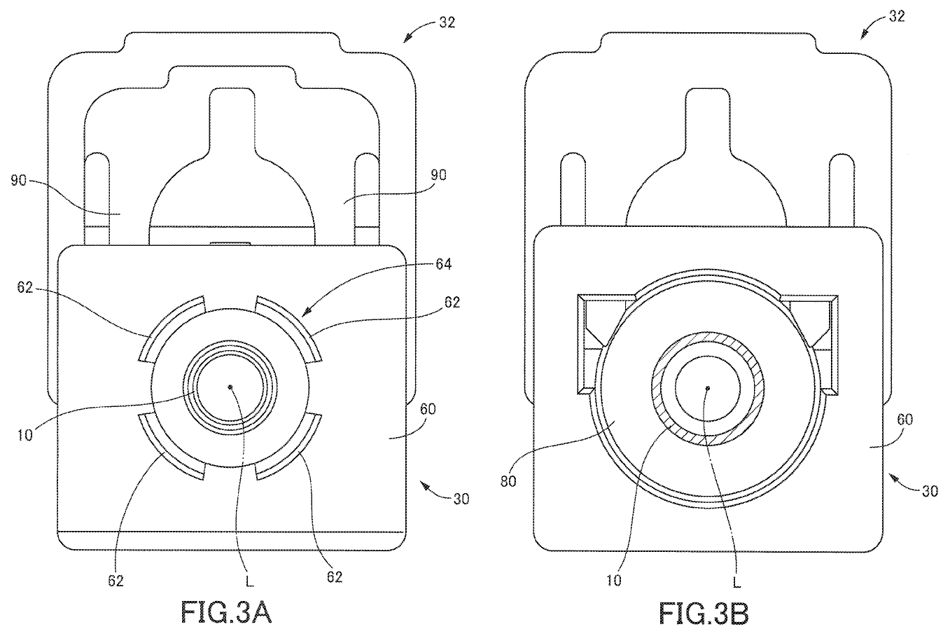

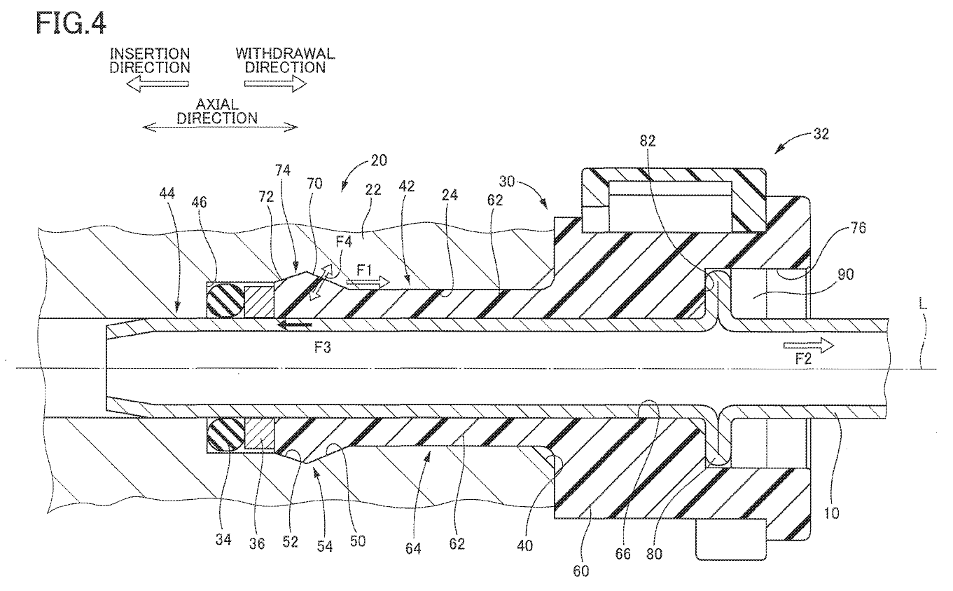

The connecting structure will now be explained referring also to the side view of FIG. 2, FIGS. 3A and 3B in which the connecting structure is viewed respectively on a front side and a rear side in the insertion direction, and the side view in cross section of FIG. 4. A receiving bore 24 is formed in the housing 22. The connecting structure includes the receiving bore 24, a connector 30 by which the tube 10 is held in the receiving bore 24, a retainer 32 for retaining the held tube 10 at a specific position with respect to the axial direction, an O ring 34 as a seal member, and a backup ring 36 supporting the O ring 34. The tube 10, the housing 22, and the backup ring 36 are formed of metal, the connector 30 and the retainer 32 are formed of resin, and the O ring 34 is formed of rubber. In FIGS. 3A and 3B, illustration of the housing 22 of the component 20 is omitted. As later explained in detail, FIG. 4 shows a state in which the retainer 32 is moved downward from its position shown in FIGS. 1-3.

The receiving bore 24 of the housing 22 is open to an exterior of the housing 22 at its one end, specifically, at its distal end in the withdrawal direction. Thus, the receiving bore 24 has an opening 40. The receiving bore 24 has: a large-diameter portion 42 located closer to the opening 40; and a small-diameter portion 44 located remote from the opening 40 and having an inside diameter smaller than that of the large-diameter portion 42. In the thus formed receiving bore 24, a stepped surface 46 is defined between the large-diameter portion 42 and the small-diameter portion 44. An annular recess 54 is formed between the stepped surface 46 and the opening 40, namely, the annular recess 54 is formed in the large-diameter portion 42. The annular recess 54 is defined by a first inclined inner circumferential surface 50 and a second inclined inner circumferential surface 52 which are inclined in mutually opposite directions with respect to the axis L.

The connector 30 includes: a connector body 60 disposed outside the receiving bore 24 of the housing 22; and a plurality of arms 62 (i.e., four arms in the connector 30 of the present connecting structure) formed integrally with the connector body 60 at respective proximal ends thereof and extending from the connector body 60 in the insertion direction. Each of the arms 62 may be referred to as a duckbill. It may be considered that the connector 30 includes a sleeve 64 constituted by the plurality of arms 62, namely, a sleeve 64 including a plurality of slits extending in the axial direction. In other words, it may be considered that the sleeve 64 has a plurality of segments arranged in the circumferential direction and divided by the slits.

As apparent from FIG. 4, a through-hole 66 is formed so as to penetrate the connector body 60 of the connector 30 in the axial direction. The through-hole 66 is connected to the space enclosed by the plurality of arms 62, i.e., the inner space of the sleeve 64, so as to be coaxial with the space. In other words, it may be considered that a bore that penetrates the connector 30 in the axial direction is formed by the inner space and the through-hole 66. An inside diameter of this bore, i.e., an inside diameter of the inner space of the sleeve 64, and an inside diameter of the through-hole 66 are substantially the same as an outside diameter of the tube 10, strictly, slightly larger than the outside diameter of the tube 10. For easy understanding of a relationship between the plurality of arms 62 and the receiving bore 24, the arms 62 are illustrated in FIG. 4 so as to be shifted by 45° in the circumferential direction.

At a distal end of each arm 62, a protruding portion 74 is defined by a first inclined outer circumferential surface 70 and a second inclined outer circumferential surface 72 which are inclined in mutually opposite directions with respect to the axis L. Viewed differently, it may be considered that the sleeve 64 includes an annular protrusion constituted by the protruding portions 74 of the respective arms 62. In a state in which the arms 62 of the connector 30 are inserted into the receiving bore 24, the first inclined outer circumferential surface 70 and the second inclined outer circumferential surface 72 of each arm 62 are respectively opposed to the first inclined inner circumferential surface 50 and the second inclined inner circumferential surface 52 of the receiving bore 24 with substantially no clearance present therebetween.

The through-hole 66 formed in the connector body 60 of the connector 30 includes, at its distal end in the withdrawal direction, a large-diameter portion 76 having a large inside diameter. The tube 10 includes an annular flange 80 formed by crushing the circumferential wall of the tube 10 in the axial direction. An inside diameter of the large-diameter portion 76 is slightly larger than an outside diameter of the flange 80. In a state in which the tube 10 is connected to the component 20, the flange 80 is disposed within the large-diameter portion 76.

FIGS. 1-4 show the state in which the tube 10 is connected to the component 20. (This state will be hereinafter referred to as a connected state where appropriate.) In the connected state, a movement of the connector 30 in the insertion direction relative to the component 20 is prohibited by contact of an end face in the insertion direction of the connector body 60 with the housing 22 of the component 20. Further, a movement of the tube 10 in the insertion direction relative to the connector 30 is prohibited such that a stepped surface 82, which defines an end in the insertion direction of the large-diameter portion 76 of the through-hole 66, stops the flange 80.

The O ring 34 is fitted on a distal end portion of the tube 10 so as to be disposed forward of the plurality of arms 62 in the insertion direction. In the connected state, the O ring 34 is pushed onto the stepped surface 46 of the receiving bore 24 by the distal ends of the respective arms 62 of the connector 30 via the backup ring 36, so as to prevent leakage of the working fluid, as a fluid, from between the tube 10 and the component 20.

For establishing the connected state, the O ring 34 and the backup ring 36 are initially inserted into the receiving bore 24, and then the connector 30 is inserted into the receiving bore 24 in the insertion direction such that the arms 62 are disposed in the receiving bore 24 until the end face in the insertion direction of the connector body 60 comes into contact with the housing 22. The arms 62 are elastically bendable such that the distal ends thereof get closer to the axis L. Upon insertion of the connector 30 into the receiving bore 24, the second inclined outer circumferential surfaces 72 of the arms 62 formed at their distal ends come into contact with the opening 40 of the receiving bore 24. In this instance, the arms 62 bend by the function of the second inclined outer circumferential surfaces 72. When the arms 62 are inserted into the receiving bore 24 to such an extent that the arms 62 cannot be inserted any more, the bending is cancelled, and the first inclined outer circumferential surface 70 and the second inclined outer circumferential surface 72 of each arm 62 are respectively opposed to the first inclined inner circumferential surface 50 and the second inclined inner circumferential surface 52 of the receiving bore 24. Subsequently, the distal end portion of the tube 10 is inserted in the insertion direction into the through-hole 66 of the connector body 60 and the space defined by the plurality of arms 62 until the flange 80 is stopped by the stepped surface 82 of the through-hole 66.

In the connected state, the first inclined inner circumferential surface 50 and the second inclined inner circumferential surface 52 of the receiving bore 24 substantially exactly fit with the first inclined outer circumferential surface 70 and the second inclined outer circumferential surface 72 of each arm 62 formed at the distal end of each arm 62. As schematically shown in FIG. 4, in the case where a force F1 in the withdrawal direction acts on the connector 30, the distal end of each arm 62 tends to bend by the engagement of the first inclined inner circumferential surface 50 and the first inclined outer circumferential surface 70, such that the distal end of each arm 62 gets closer to the axis L. That is, owing to what is called wedge effect of the first inclined outer circumferential surface 70 and the first inclined inner circumferential surface 50, each arm 62 tends to be moved such that the distal end thereof gets closer to the axis L. In the present connecting structure, however, the tube 10 is substantially tightly fitted in the space enclosed by the arms 62. Therefore, the arms 62 do not substantially bend. Instead, the tube 10 is gripped by the arms 62 from outside. The first inclined outer circumferential surface 70 of each arm 62 functions as a first engaging portion provided on the outer circumferential portion of the distal end of the arm 62, and the first inclined inner circumferential surface 50 functions as a second engaging portion provided on the inner circumferential surface of the receiving bore 24 so as to be engageable with the first engaging portions. The first engaging portions and the second engaging portion constitute a holding and withdrawal prohibiting mechanism configured to prohibit a movement of the connector 30 in the withdrawal direction relative to the component 20 while gripping the tube 10 by the arms 62. In this respect, the second inclined inner circumferential surface 52 and the second inclined outer circumferential surface 72 function similarly to the first inclined inner circumferential surface 50 and the first inclined outer circumferential surface 70, so as to prohibit the movement of the tube 10 in the insertion direction relative to the connector 30.

According to the holding and withdrawal prohibiting mechanism, in the case where a force F2 to withdraw the tube 10 acts from outside the connector 30, namely, in the case where the force F2 to withdraw the tube 10 acts on the tube 10 from outside the component 20, the tube 10 is gripped by the arms 62, so that there is generated, between the arms 62 and the tube 10, a frictional force F3 that counters at least a part of the force F2 in the withdrawal direction acting on the tube 10, and a movement of the tube 10 in the withdrawal direction relative to the connector 30 is suppressed by the frictional force F3.

The force F1 in the withdrawal direction that acts on the connector 30 may be a force that acts on the connector 30 via the frictional force between the tube 10 and the arms 62 arising from the force F2 that acts on the tube 10 from outside the component 20 to withdraw the tube 10. That is, even when only the tube 10 will be withdrawn, the connector 30 will be also withdrawn due to friction between the tube 10 and the arms 62 if a friction coefficient therebetween is large. This force to withdraw the connector 30 suppresses withdrawal of the tube 10 from the connector 30. Further, in the connected state, the elastic reaction force of the O ring 34 acts on the connector 30 at the distal ends of the arms 62. The elastic reaction force serves as the force F1 in the withdrawal direction acting constantly on the connector 30, whereby the tube 10 is effectively prevented from being withdrawn from the component 20.

Though the frictional force F3 may counter the entirety of the force F2 to withdraw the tube 10 from outside, the present connecting structure is configured such that the retainer 32 held by the connector body 60 of the connector 30 also prohibits the movement of the tube 10 in the withdrawal direction relative to the connector 30. Specifically, the retainer 32 includes a pair of stopper arms 90. When the retainer 32 is located at a first position shown in FIG. 3, the pair of stopper arms 90 do not stop the flange 80 of the tube 10. When the retainer 32 is moved downward from the first position to a second position shown in FIG. 4, the pair of stopper arms 90 stop the flange 80 of the tube 10. That is, when the retainer 32 is moved from the first position to the second position, the stopper arms 90 are interposed between a portion of the flange 80 and a portion of the connector body 60 of the connector 30, and the connector body 60 prohibits the movement of the tube 10 in the withdrawal direction relative to the connector 30 via the pair of stopper arms 90. In the present connecting structure, therefore, a part of the force F2 to withdraw the tube 10 from the connector 30 is received by the retainer 32. Conversely, the retainer 32 is configured to receive only a part the force F2 to withdraw the tube 10 from the connector 30.

The connecting structure constructed as described above has a high strength because the connecting structure is not configured such that only the retainer 32 bears the force to prohibit the withdrawal of the tube 10 from the component 20. In other words, the inner circumferential surface of the receiving bore 24, i.e., the first inclined inner circumferential surface 50, formed in the housing 22 of the component 20 bears at least a part of the force that prohibits the withdrawal of the tube 10 from the component 20, via: the frictional force F3 generated between the plurality of arms 62 and the tube 10; and the protruding portions 74 of the respective arms 62. That is, there is generated, between the first inclined inner circumferential surface 50 and the first inclined outer circumferential surfaces 70 of the respective arms 62, an action and reaction force F4 orthogonal to those circumferential surfaces 50, 70, whereby the housing 22 bears at least a part of the force to prohibit the withdrawal of the tube 10 from the component 20. Thus, the present connecting structure has a high strength. In this respect, even if the force in the withdrawal direction acts on the tube 10, the bending force does not substantially acts on the distal ends of the arms 62, but the compression force and the shearing force mainly act on the distal ends of the arms 62, resulting in a high strength of the connector 30 itself.

In view of the function of the connecting structure as explained above, the frictional force generated between the first inclined inner circumferential surface 50 of the receiving bore 24 and the first inclined outer circumferential surfaces 70 of the respective arms 62 of the connector 30 is desirably made small. Further, the frictional force generated between the outer circumferential surface of the tube 10 and an inner circumferential surface of the distal end of each arm 62 is desirably made large. In view of this, a lubricant may be provided between the first inclined inner circumferential surface 50 and the first inclined outer circumferential surface 70 of each arm 62 or the surface roughness of the first inclined inner circumferential surface 50 and the first inclined outer circumferential surface 70 of each arm 62 may be made low. On the contrary, a film formed of rubber may be provided between the outer circumferential surface of the tube 10 and the inner circumferential surface of the distal end of each arm 62, at least one of the outer circumferential surface of the tube 10 and the inner circumferential surface of the distal end of each arm 62 may be non-smooth, or the surface roughness of the outer circumferential surface of the tube 10 and the inner circumferential surface of the distal end of each arm 62 may be made high. In the present connecting structure, by adjusting the surface roughness, the friction coefficient between the first inclined inner circumferential surface 50 and the first inclined outer circumferential surface 70 of each arm 62 is made smaller than the friction coefficient between the outer circumferential surface of the tube 10 and the inner circumferential surface of the distal end of each arm 62.

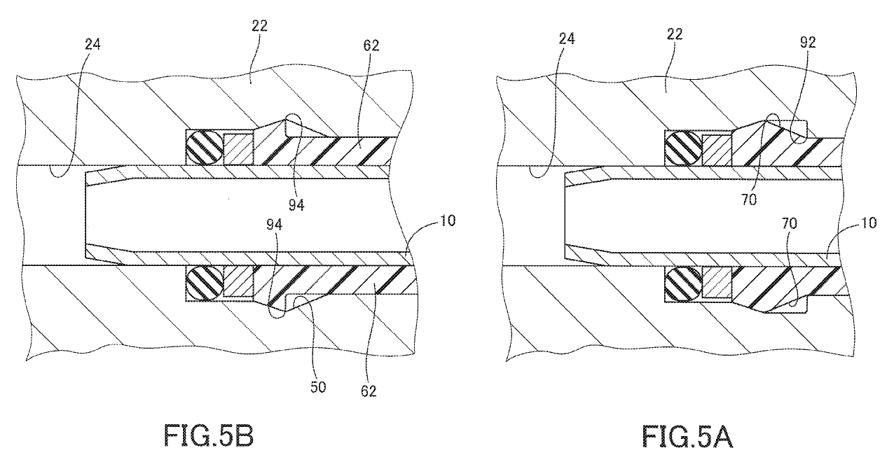

The connecting structure according to the illustrated embodiment includes: the first inclined outer circumferential surfaces 70 each as the first engaging portion provided on the outer circumferential portion of the distal end of the corresponding arm 62; and the first inclined inner circumferential surface 50 as the second engaging portion provided on the inner circumferential surface of the receiving bore 24 so as to be engageable with the first engaging portions. That is, the first engaging portions and the second engaging portion are respectively formed as the first inclined surfaces and the second inclined surface to be opposed to each other. The two surfaces are to be held in surface contact with each other, thus enabling the wedge effect by the two surfaces to be smoothly exhibited. In place of this configuration, only one of: each of the first engaging portions; and the second engaging portion may be formed as an inclined surface, and the other of: each of the first engaging portions; and the second engaging portion may be configured to be held in line contact with the inclined surface. The thus modified connecting structure employing such a configuration also adequately exhibits the wedge effect described above. Specifically, as shown in FIG. 5A, in place of providing the first inclined inner circumferential surface on the receiving bore 24 of the housing 22, an edge 92 formed on the inner circumferential surface of the receiving bore 24 may serve as the second engaging portion. In this modification, owing to the wedge effect exhibited by the first inclined outer circumferential surface 70 of each arm 62, the movement of the connector 30 in the withdrawal direction relative to the component 20 is prohibited while the tube 10 is gripped by the arms 62. Alternatively, as shown in FIG. 5B, in place of providing the first inclined outer circumferential surface at the distal end of each arm 62, an apex 94 of the distal end of each arm 62 may serve as the first engaging portion. In this modification, owing to the wedge effect exhibited by the first inclined inner circumferential surface 50 formed on the inner circumferential surface of the receiving bore 24, the movement of the connector 30 in the withdrawal direction relative to the component 20 is prohibited while the tube 10 is gripped by the arms 62.

What is claimed is:

1. A connecting structure employed in a fluid system for connecting a tube to a component of the fluid system such that a fluid is allowed to flow into and out of the component, comprising:
a receiving bore provided in the component and opening at one end thereof; and
a connector including (a) a connector body and (b) a plurality of arms extending from the connector body along an axis so as to be arranged about the axis, each of the plurality of arms being elastically bendable such that a distal end thereof gets closer to the axis, the connector being inserted into the component in an axial direction in which the axis extends such that the plurality of arms are disposed in the receiving bore, one end of the tube extending through the connector in the axial direction so as to be surrounded by the plurality of arms in a state in which the connector is inserted into the component,
wherein the connecting structure further comprises a holding and withdrawal prohibiting mechanism including: first engaging portions each provided on an outer circumferential portion of the distal end of a corresponding one of the plurality of arms; and a second engaging portion provided on an inner circumferential surface of the receiving bore so as to be engageable with the first engaging portions, and
wherein, when the connector is biased in a withdrawal direction opposite to an insertion direction in which the connector is inserted into the component, the holding and withdrawal prohibiting mechanism prohibits a movement of the connector relative to the component in the withdrawal direction while gripping the tube by the plurality of arms, owing to engagement of the first engaging portions and the second engaging portion.

2. The connecting structure according to claim 1, wherein one of: each of the first engaging portions; and the second engaging portion is an inclined surface that is inclined with respect to the axis.

3. The connecting structure according to claim 2, wherein, where the inclined surface is a first inclined surface, the other of: each of the first engaging portions; and the second engaging portion is a second inclined surface configured to be opposed to the first inclined surface when the first engaging portions and the second engaging portion come into engagement with each other.

4. The connecting structure according to claim 1, further comprising a flange provided on an outer circumference of the tube,
wherein a movement of the connector in the insertion direction is prohibited in the state in which the connector is inserted into the component, and the connector is configured to stop the flange so as to prohibit a movement of the tube in the insertion direction relative to the connector.

5. The connecting structure according to claim 4, further comprising a retainer held by the connector body of the connector and configured to retain the flange so as to prohibit a movement of the tube in the withdrawal direction relative to the connector.

6. The connecting structure according to claim 5, wherein the retainer is held by the connector body of the connector so as to be movable between a first position at which the retainer does not retain the flange and a second position at which the retainer retains the flange.

7. The connecting structure according to claim 1, further comprising a seal member disposed forward of the distal end of each of the plurality of arms of the connector in the insertion direction, so as to fluid-tightly seal between an outer circumferential surface of the tube and the inner circumferential surface of the receiving bore.

8. The connecting structure according to claim 7,
wherein the receiving bore includes a stepped surface by which a movement of the seal member in the insertion direction is prohibited, and
wherein the seal member is pushed onto the stepped surface by the distal end of each of the plurality of arms in the state in which the connector is inserted into the component.
